(19) United States
(12) Patent Application Publication
(10) Pub. No.: US 2011/0022465 A1
(43) Pub. Date: Jan. 27, 2011

(54) System and Method for Managing Online Experiences Based on User Sentiment Characteristics and Publisher Targeting Goals

(76) Inventors: Prasannakumar Jobigenahally Malleshaiah, Bangalore (IN); Supreet Hosur Nagesh Rao, Bangalore (IN)

Correspondence Address: Stattler-Suh PC, 60 SOUTH MARKET, SUITE 480, SAN JOSE, CA, 95113, US

(21) Appl. No.: 12/509,209

(22) Filed: Jul. 24, 2009

(51) Int. Cl. G06Q 30/00; G06F 3/01; G06F 15/16

(52) U.S. Cl. 705/14.54; 715/760; 709/206

(57) ABSTRACT

A computer-implemented method, apparatus, and computer readable medium product for presenting to a user, a message (for achievement of the message publisher's goal) in the form of one or more display pages based on combined user demographics and user sentiment-related relevance attribute values. The method includes receiving sentiment-related (that is, sentigraphic) vector data structures wherein the sentigraphic vector is configured to indicate one or more user-specific sentiment-related relevance attribute values, which values are correlated to demographic data structures. In embodiments, the method includes inferring sentigraphic attribute values based on the demographic data structure. Inferred sentigraphic attributes extend demographics in the sense that at least some sentigraphic attribute values are not present in the demographic data structure. The method implements techniques for performing automated layout of display pages before presenting to the user the message in the form of pages displayed on any sort of client system, computer, or mobile terminal.

### FIELD OF THE INVENTION

The present invention is directed towards management of on-line user experiences based on sentiments.

### BACKGROUND OF THE INVENTION

The marketing of products and services online over the Internet through advertisements is big business. Various types of publishing over the Internet seek to reach individuals within a target set having very specific demographics (e.g. male, age 40-48, graduate of Stanford, living in California or New York, etc). This targeting of very specific demographics is in significant contrast to print and television messaging that is generally capable of reaching only an audience within some broad, general demographics (e.g. living in the vicinity of Los Angeles, or living in the vicinity of New York City, etc). The single appearance of a publisher's message through one or more display pages (e.g. web pages, messages on a smart phone, etc) is known as an online impression. Each display of a page delivered to a user represents an impression opportunity to display a message in some portion of the displayed page to the individual user.

Social scientists have observed that measurable aspects of an experience of a particular individual may vary from the measurable aspects of an experience of a different user. Moreover, measurable aspects of an experience of a particular individual may vary depending on various factors affecting the user including geography, timing, economic climate, and even more fleeting situations such as social pressures, happenings at home or work, known or latent interests, preferences, and even sentiments.

Some of the aforementioned factors are known as demographics, and are often used in identifying targeted audiences of individuals for publishing content (e.g. in print media, broadcasting, or Internet messaging) that serves the demographic. With the advent and widespread availability of Internet publishing, not only target audiences (i.e. those individuals sharing some particular demographics), but also specific individuals can be reached with published content that is specific to that particular individual user. Direct mail publishing can sometimes reach a particular user with a particular semi-customized message (e.g. “Dear Mr. Lee III, Robert E.” etc), and a customized message (e.g. “You are eligible to reduce your mortgage of $325,000 at 7.25% down to one of our favorable, low, low rates if you call our representatives now.”).

Internet messaging may present messages to a particular individual user based on that particular user's online behavior. For example, an online bookseller might recommend additional titles related to organic food science based on the user's purchase of (for example) an organic food recipe book. However, such systems do not take into account the sentiments of the particular user. By combining both demographics and user sentiments (e.g. opinions related to external influences, recent online user behavior, expressed user sentiment, etc) more effective messaging (e.g. specific content, targeted messaging, web layouts, ambience, etc) can be presented to the user. Thus, a system that can retrieve and/or infer user sentiment and use such sentiment to customize the messaging is needed.

Other automated features and advantages of the present invention will be apparent from the accompanying drawings and from the detailed description that follows below.

### SUMMARY OF THE INVENTION

Embodiments of the invention for managing online experiences based on user sentiment characteristics and publisher targeting goals seek to match available messages, which messages include target sentiments, to users who are known to hold a matching sentiment; and to present the messages in a form expressly suited to match the user's sentiment. Processing includes receiving a sentiment-related (that is, sentigraphic) vector data structure wherein the sentigraphic vector is configured to indicate one or more user-specific sentiment-related relevance attribute values, which values are correlated with demographic data structures. In various embodiments, the method includes inferring sentigraphic attribute values based on the demographic data structure. Inferred sentigraphic attributes extend demographics in the sense that at least some sentigraphic attribute values are not present in the demographic data structure. Various techniques are employed for matching the target sentiments of available messages to users who are known (or suspected, by inference) to hold matching sentiments. Methods implement techniques for performing automated layout of display pages (using the inferred sentigraphic attribute values) before presenting to the user the message in the form of customized pages displayed on any sort of client system, computer, or mobile terminal.

### BRIEF DESCRIPTION OF THE DRAWINGS

The novel features of the invention are set forth in the appended claims. However, for purpose of explanation, several embodiments of the invention are set forth in the following figures.

FIG. 1 shows a client-server computing environment in which some embodiments operate.

FIG. 2 is a depiction of a system showing data flow from publisher campaign requirements to display of messages, according to one embodiment.

FIG. 3 is a depiction of a system for managing online experiences based on user sentiment characteristics and publisher targeting goals, according to one embodiment.

FIG. 4 is a depiction of an exemplary data structure of a publisher object, according to one embodiment.

FIG. 5 is a depiction of an exemplary data structure of a user object, according to one embodiment.

FIG. 6 is a depiction of a modularized system for processing user sentiment characteristics and publisher targeting goals, according to one embodiment.

FIG. 7 is a flowchart showing operations for processing user sentiment characteristics and publisher targeting goals, according to one embodiment.

FIG. 8 is a depiction of a modularized system for processing automated page layout using sentiment characteristics, according to one embodiment.

FIG. 9 is a diagrammatic representation of a client-server computing environment in the exemplary form of several computer systems, within which a set of instructions may be executed, according to according to one embodiment.

FIG. 10 is a flowchart showing operations for processing user sentiment characteristics and publisher targeting goals, according to one embodiment.

FIG. 11 is a diagrammatic representation of a data flow for presenting pages based on user sentiment characteristics and publisher targeting goals, according to one embodiment.

FIG. 12 is a flowchart showing a method for presenting pages based on user sentiment characteristics and publisher targeting goals, according to one embodiment.

FIG. 13 is a diagrammatic representation of a machine in the exemplary form of a computer system, within which a set of instructions may be executed, according to according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

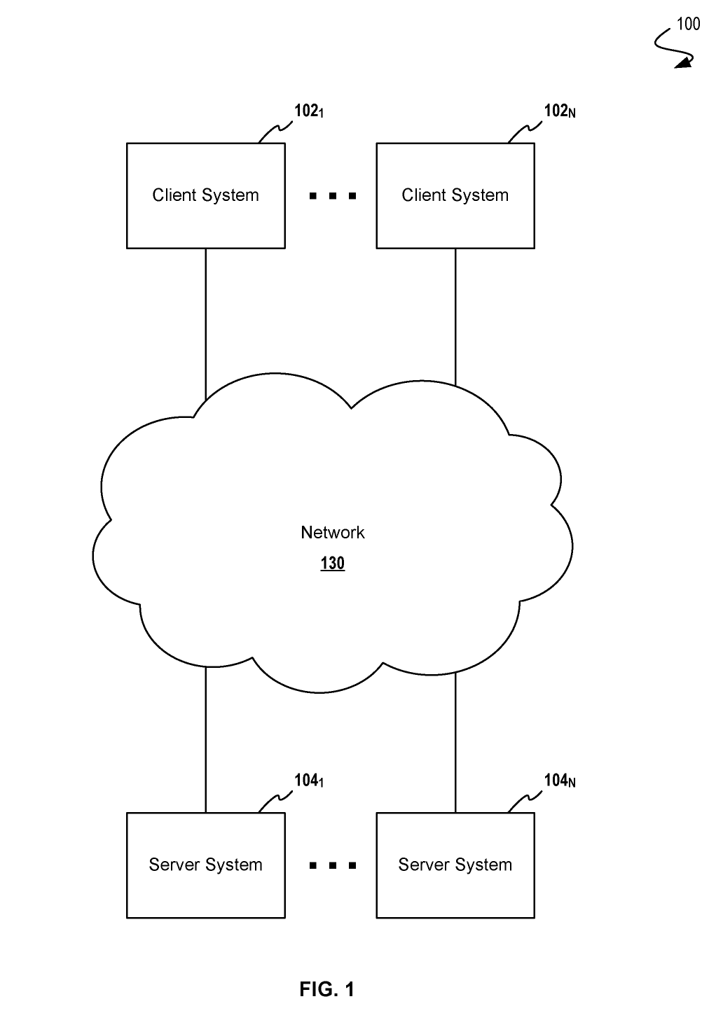

In the context of Internet publishing, placement of messages customized to a particular demographic or particular user within an Internet environment has become common. By way of a simplified description, and referring to the environment 100 of FIG. 1, showing a client-server computing environment in which some embodiments may operate, an Internet publisher may select a particular property (e.g. the landing page for the Empire State, empirestate.com), and may create one or more display pages including customized messages such that whenever any Internet user, via a client system 102₁-102_{N}, renders the display pages from an Internet property, the display pages, including customized messages, is composited by a server system 104₁-104_{N} for delivery to a client system 102 over a network 130. This model is common for property-oriented messaging, especially where the customized message is composited based on demographics (e.g. only displays a particular customized message to users living in California).

In the slightly more sophisticated model, and referring to system 200, an Internet publisher might desire placement of highly customized messages, i.e. specifically customized to a particular demographic or customized to a particular user who falls into some explicit or derived demographic. As an example, a publisher might want to reach users who are “between 26 and 30 years old”. A user whose age demographic characteristic (i.e. the age of the user) is known (e.g. via a cookie or via the user's online profile) to be 27 years old can be derived or inferred to fall into the “between 26 and 30 years old” demographic. In a more sophisticated model, an Internet publisher might desire placement of highly customized messages, i.e. specifically customized to a particular user who holds a particular opinion or sentiment. As an example, within a particular publisher's messaging campaign, the publisher might want to reach users who are “bullish about US Blue Chip value stocks”. In this situation, one can infer that a user who has recently purchased US Blue Chip value stocks might be “bullish about US Blue Chip value stocks”. In a similar situation, one can infer that a user who has recently posted a comment to a blog that indicates the sentiment of being “bullish about US Blue Chip value stocks” might indeed be “bullish about US Blue Chip value stocks”. Conversely, if within a particular publisher's messaging campaign, if the publisher wants to reach users who are “likely to purchase an iPod” and if one can infer that a particular user holds a sentiment that is “strongly negative toward iPod”, then there would be little point in displaying positive messages regarding iPod (e.g. where to buy, available discounts or bundles, etc).

### General Terms and Operating Environments

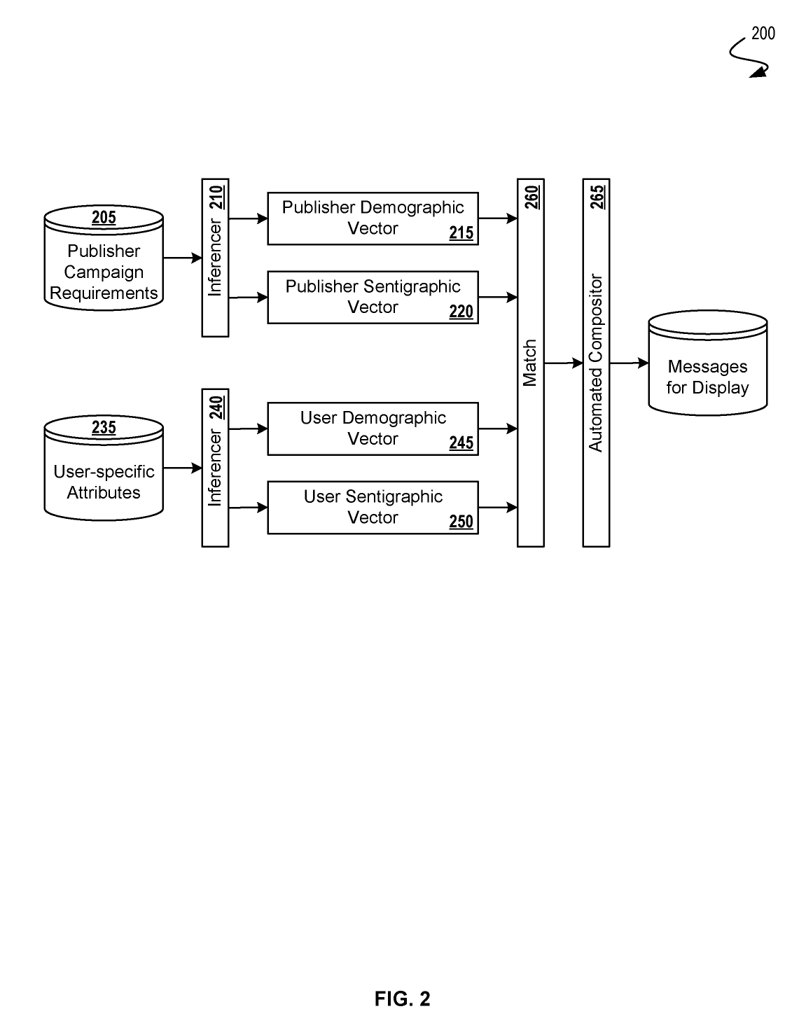

FIG. 2 is a depiction of a system showing data flow from publisher campaign requirements to display of messages, according to one embodiment. As shown, the system 200 includes a database of publisher campaign requirements 205 that might contain representations of specific target demographics (e.g. “between 26 and 30 years old”, “is a student at an accredited university”, etc) and might also contain specific target sentigraphics (e.g. “bullish about US Blue Chip value stocks”, “is positively dispositioned toward the iPod” etc). These specific target demographics and specific target sentigraphics might be processed by a publisher campaign requirements inferencer module 210 that might in turn produce a computer-readable representation of the aggregation of demographics and sentigraphics into a publisher demographic vector 215 and a publisher sentigraphic vector 220, respectively. In some embodiments, the inferencer module 210 receives specific target sentigraphics by receiving a sentigraphic vector data structure that includes an association with one or more publishing campaigns taken from database of publisher campaign requirements 205.

A user inherently possesses various demographic characteristics (e.g. age, gender, etc), and such demographics might be represented as an attribute-value pair. For example, a user might be a member of a demographic (age=26), where “age” is the demographic attribute and “26” is the attribute value. Of course a natural person inherently possesses a nearly infinite number of demographics such as (gender=male), (married=true), (offspring=3), (tattoo=none) and etcetera. In some settings, certain demographic attribute-value pairs are relevant to messaging (e.g. age, gender, etc) and relevant demographic data structures can be retrieved in whole or in part from an online database (e.g. from a user's Yahoo! profile, from a user's Facebook profile, etc). In other settings, certain demographic attribute-value pairs might be regarded as irrelevant to messaging (e.g. tattoo=none).

FIG. 2 also includes a user-specific attributes database 235 from which attributes might be processed by a user-specific attribute inferencer module 240 that might in turn produce a computer-readable representation of the aggregation of user-specific attributes into a user demographic vector 245 and a user sentigraphic vector 250, respectively. Given a publisher demographic vector 215 and a user demographic vector 245, a match score (or vector of scores) based on demographics might be calculated by a match module 260. Similarly, given a publisher sentigraphic vector 220 and a user sentigraphic vector 250, a match score (or vector of scores) based on sentigraphics might also be calculated by a match module 260. Continuing, having a match score (or vector of scores) for both demographics and sentigraphics, a message might be customized to the user using an automated compositor 265.

An output of a user-specific attribute inferencer module 240 includes a user sentigraphic vector 250 that might quantify or otherwise codify inferred generalized user sentiment, (e.g. happiness, contentedness, etc). Such generalized sentiments of natural persons involves many factors, possibly including economic well-being, outlook on economic growth, outlook on personal income, etc. and may be influenced in both absolute and relative terms by factors such as physical location of the user (e.g. is the user in a developed country or a newly industrialized country, or in an undeveloped country). Table 1 presents a non-exhaustive set of attributes and indicators that would tend to influence such generalized user sentiments.

TABLE 1

| Attribute | Examples of Influencing Indicators |
|---|---|
| Personal Income | Absolute income, income relative to others |
| | of similar demographics |
| Personal Economic Outlook | Recent purchases as a percentage of |
| | personal income |
| Broad Economic Outlook | Indicators from news content, stock |
| | market indices |
| Level of Education | Degrees obtained, current student status |
| Family Situation | Single, married, currently or recently |
| | involved in a divorce; recent family |
| | events |
| Work Environment | Type of occupation, dirtiness, danger or |
| | drudgery of occupation |
| Location | Events occurring (or just occurred or soon to |
| | occur) in the location |
| Date & Time | Day of week, season, time of day |
| Predilections | Online behaviors |
| Brand Preferences | Cross-marketed product brand preferences |
| Mood | Words used in postings where the words |
| | used mood terms |

Of course, for the purpose of managing online experiences based on user sentiment characteristics and publisher targeting goals, an implementation such as system 200 might take into account more specific sentiments, including user wants or desires, and/or user opinions on specific topics. Some examples might be expressed as, “interested in sports”, or “interested in baseball”, or “is a job seeker”, or “prefers German-made automobiles”. For example, managing online experiences might include inferring user preferences by extracting sentiment from at least one of the user's expressed interest, the user's search terms, the user's recently viewed content, the user's web page feeds, the user's public messaging, the user's recently viewed pages, the user's recent ad clicks, etc. Such inferences might then be further used for purposes of managing online experiences by presenting content that is relevant to user sentigraphics.

A system such as system 200 takes into account known user attributes, infers influencing indicators, and improves the online experience by presenting content that is relevant not only to user demographics, but also to user sentigraphics. A system 200 that includes an automated compositor can present base content with modifications that are specifically suited to a particular user. Examples of such modifications include modification of search results pages, selection of ads, modifications to web layout, modifications to colors, themes, ambience, etc.

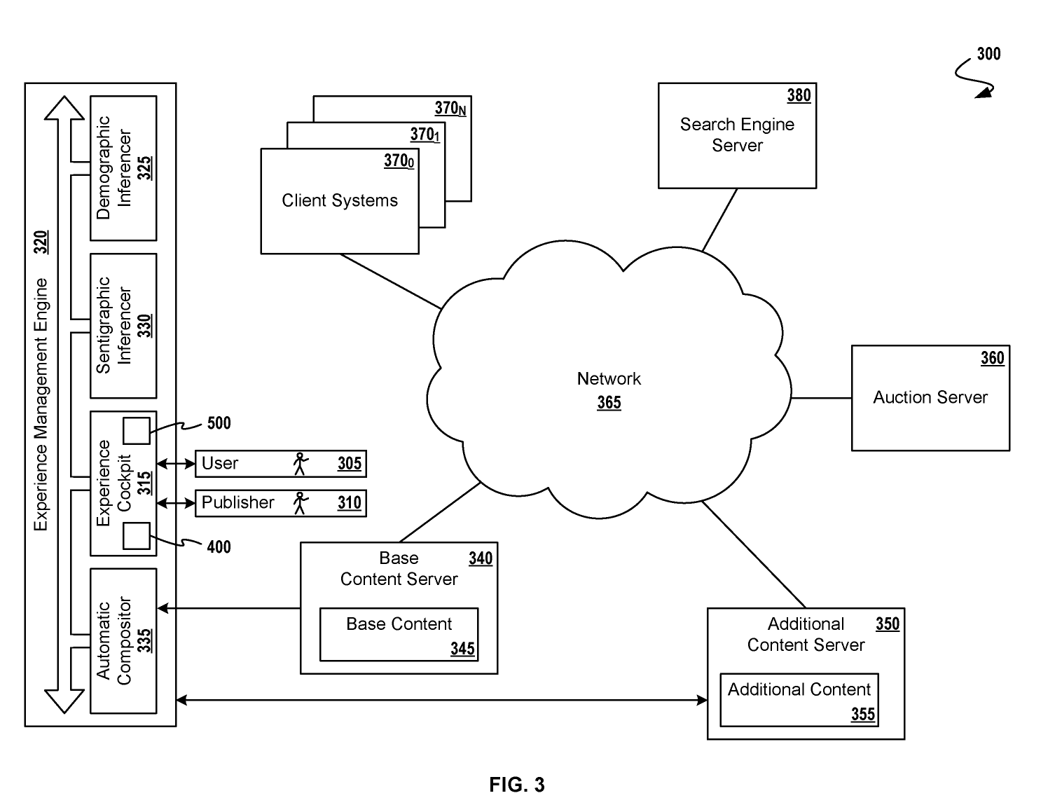

FIG. 3 is a depiction of a system for managing online experiences based on user sentiment characteristics and publisher targeting goals, according to one embodiment. As shown, the system 300 for managing online experiences based on user sentiment characteristics and publisher targeting goals includes a user 305 and a publisher 310 interacting with an experience cockpit module 315, which experience cockpit module 315 is a module within an experience management engine 320. Through an interface (e.g. graphical user interface, SMS interface, etc), a publisher can specify publisher campaign requirements (possibly in the form of publisher campaign requirements 205) and/or a user can specify user-specific attributes (possibly in the form of a user-specific attributes database 235). The experience management engine 320 coordinates information and processing between the experience cockpit module 315, a demographic inferencer module 325, a sentigraphic inferencer module 330, and an automatic compositor module 335. The automatic compositor module serves to manage presentation and layout aspects of a user's online experience. In some embodiments the automatic compositor module 335 can be configured for adjusting displayed content or otherwise adjusting facets of the online experience. Examples of facets of online experience include any combination of the modifications, (e.g. modifications of search results pages, selection of ads, modifications to web layout, modifications to colors, themes, ambience, etc) and/or in combination with the selection or presentation of particular content including specially-selected page content, possibly including selection of content displayed to a user based on only some particular user sentiments. Even more, management of a user online experience may include selected glue page content, front page content, pulse content, and may even include selection of ads, discounts, deals, multimedia recommendations, and articles or news.

As shown, the automatic compositor is configured for communication with a base content server 340, which content server hosts base content 345. Base content might be provided by a publisher and, in particular, in a format that is easily modified. For example, a publisher (e.g. Yahoo! Finance) might lay out pages with well-defined rectilinear areas to hold specific types of content, and the content might be inserted into the rectilinear area. In some cases, the inserted content might differ from time to time (e.g. stock quotes), yet be presented to all users regardless of user demographics or user sentiments. In other cases, a rectilinear area might be filled with additional content that is defined on a per-user basis. In fact, a user viewing a Yahoo! Finance web page might see messages that are selected on the basis of the user's demographics or the user's sentiments. For example a user whose demographics indicates they are of an age and income level to purchase an automobile, and whose sentiments indicate a dislike for imported automobiles, might receive a Yahoo! Finance web page containing messages for only American-made automobiles. The extent of such additional content is limited only by access to one or more additional content servers 350 and access to the additional content 355 available at such additional content servers. Returning to the previous example, a publisher (e.g. Yahoo! Finance) might lay out pages with well-defined rectilinear areas to hold specific types of content, and such content might include results from a search engine server 380 that would then be inserted into the rectilinear area.

In certain situations, multiple publishers compete for the opportunity to display a particular message to a particular user with particular demographic or sentigraphic characteristics. Indeed, given a particular impression opportunity, there may be significant competition among publishers for the chance to provide messages to that specific individual Internet user.

In the context of Internet systems, competition among publishers is often resolved by an auction, and the winning bidder's messages are shown in the available spaces of the impression. Such an auction may be performed by an auction server 360. In this embodiment, the winning bidder is communicated to the additional content server 350 and such additional content can be retrieved by the automatic compositor module 335 over a network 365. The composited page or pages are then displayed to the user via one or more client systems 370₀-370_{N}.

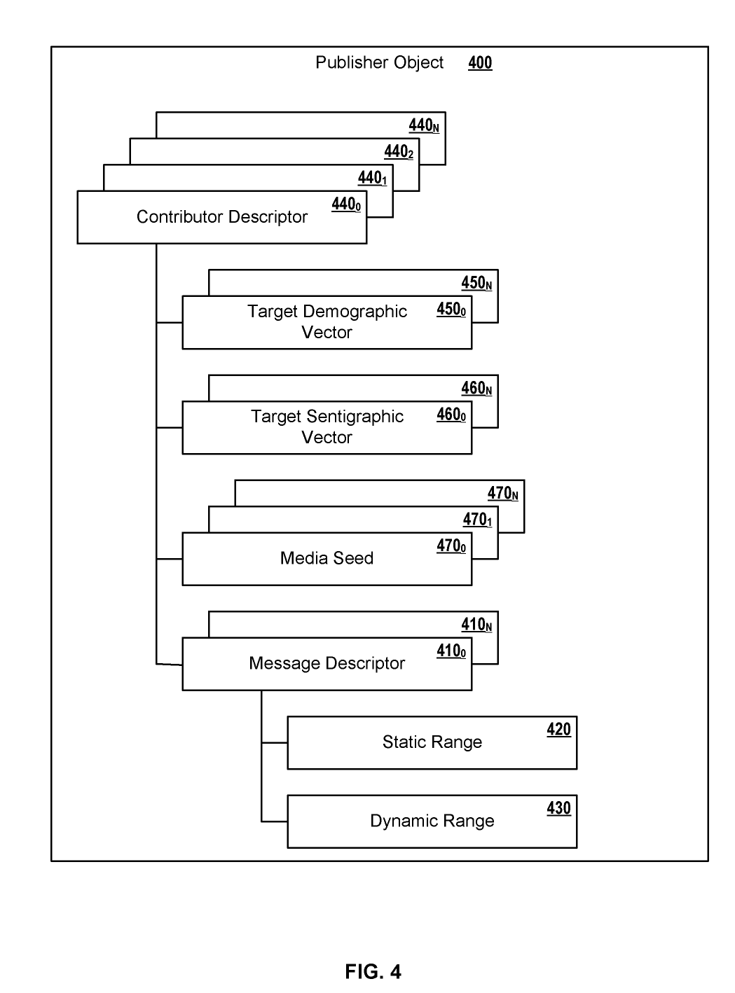

FIG. 4 is a depiction of an exemplary data structure of a publisher object 400, according to one embodiment. As earlier described, given a publisher sentigraphic vector 220 and a user sentigraphic vector 250, a match score (or vector of scores) based on sentigraphics might be calculated by a match module 260. In some embodiments, a data structure in the form of a publisher object 400 is allocated within a computer memory and populated with data. An exemplary publisher object 400 might comprise one or more contributor descriptors 440₀-440_{N}. A contributor description might in turn comprise one or more target demographic vectors 450₀-450_{N}, and one or more target sentigraphic vectors 460₀-460_{N}. Further, an exemplary publisher object 400 might comprise one or more media seeds 470₀-470_{N} and one or more message descriptors 410₀-410_{N}.

The one or more contributor descriptors 440₀-440_{N} might comprise a publisher's name, a URL to the publisher's web pages, possibly including the URL to the specific page or pages that are the subject of an impression opportunity. Of course other information describing the contributor need not be specific to a single page. In exemplary embodiments, a page provided by a publisher might be composed from a plurality of contributors. Hence, and as shown in FIG. 4, a publisher object 400 might contain one or more contributor descriptors 440₀-440_{N}, each corresponding to a component of an impression.

Any single component of an impression might be associated with one or more demographics. Hence, the one or more target demographic vectors 450₀-450_{N} might serve to characterize the target demographics for each single component.

Similarly, any single component of an impression might be associated with one or more sentigraphics. Hence, the one or more target sentigraphic vectors 460₀-460_{N} might serve to characterize the target sentigraphics for each single component.

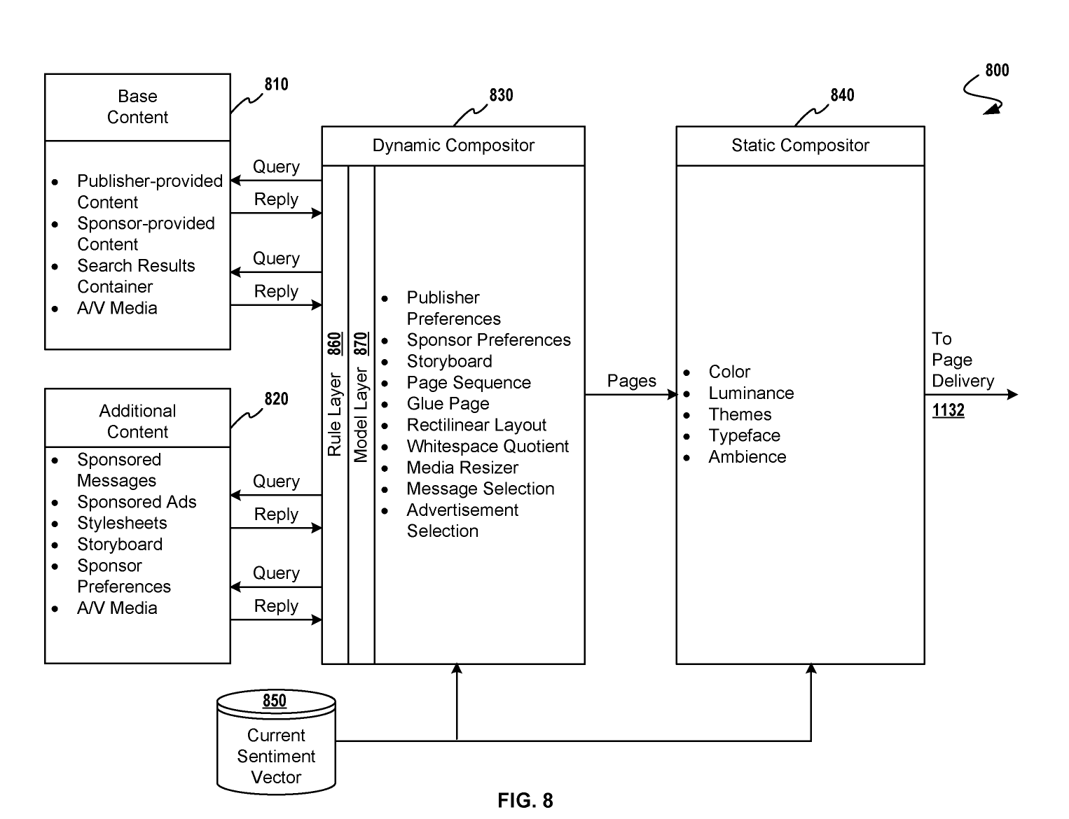

As regards the operations of a compositor (see FIG. 8), the composition of an impression might include use of media (e.g. audio, video, sense recordings, etc), and such media might be suggested via one or more media seeds 470₀-470_{N}. Such a seed might come in the form of a URL to the location of the media, and/or it might describe some portion (e.g. clip) of the media.

The one or more message descriptors 410₀-410_{N} serve to describe characteristics of a message, which characteristics might be used in compositing. For example, a message might comprise an image, a media clip, and/or text. The sponsor of the message might wish to display the message in multiple contexts, any of which might differ in some visible regard (e.g. different screen area, different aspect ratio, different ornamentation, etc). Of course, the range of possibilities of visible display content might be vast. To control the flexibility of resulting displays of the message while still controlling display characteristics that the sponsor deems important, a sponsor or agent might include certain characteristics (e.g. corporate colors, placement of corporate logo, etc) in the descriptor of the static range 420, and other characteristics (e.g. aspect ratio, border, text message, etc) in the descriptor of the dynamic range 430.

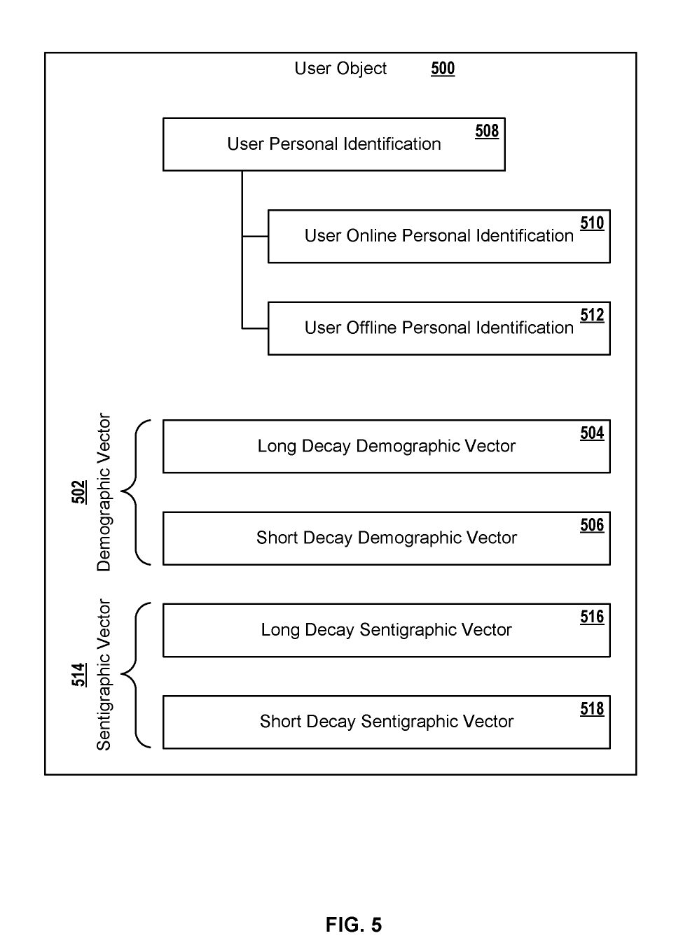

FIG. 5 is a depiction of an exemplary data structure of a user object 500, according to one embodiment. As earlier described, given a user sentigraphic vector 250 and a publisher sentigraphic vector 220, a match score (or vector of scores) based on sentigraphics might be calculated by a match module 260. In some embodiments, a data structure in the form of a user object 500 is allocated within a computer memory, and populated with data. An exemplary user object 500 might comprise a field for user personal identification 508. A user personal identification 508 might in turn comprise a field for user online personal identification 510 and a field for user offline personal identification 512. Further, an exemplary user object 500 might comprise one or more fields for a demographic vector 502 and one or more fields for a sentigraphic vector 514.

As just previously described, an exemplary user object 500 might comprise a field for user personal identification 508. Strictly as an example, a field for user personal identification 508 might comprise data from a user's cookie, or might comprise a URL to a user's profile. User personal identification might be segregated into a user's online personal identification 510 (e.g. screen name, email alias, recent search terms, etc) and/or a user's offline personal identification 512 (e.g. recent credit card purchases at a major department store, user's mobile telephone number, etc).

A demographic vector 502 comprising a sub-vector for long decay treatment 504 and/or a sub-vector for short decay treatment 506 might be provided, and such treatment of demographic vectors is discussed infra. In similar fashion, a sentigraphic vector 514 comprising a sub-vector for long decay treatment 516 and/or a sub-vector for short decay treatment 518 might be provided, and such treatment of sentigraphic vectors is also discussed infra.

### Systems and Methods

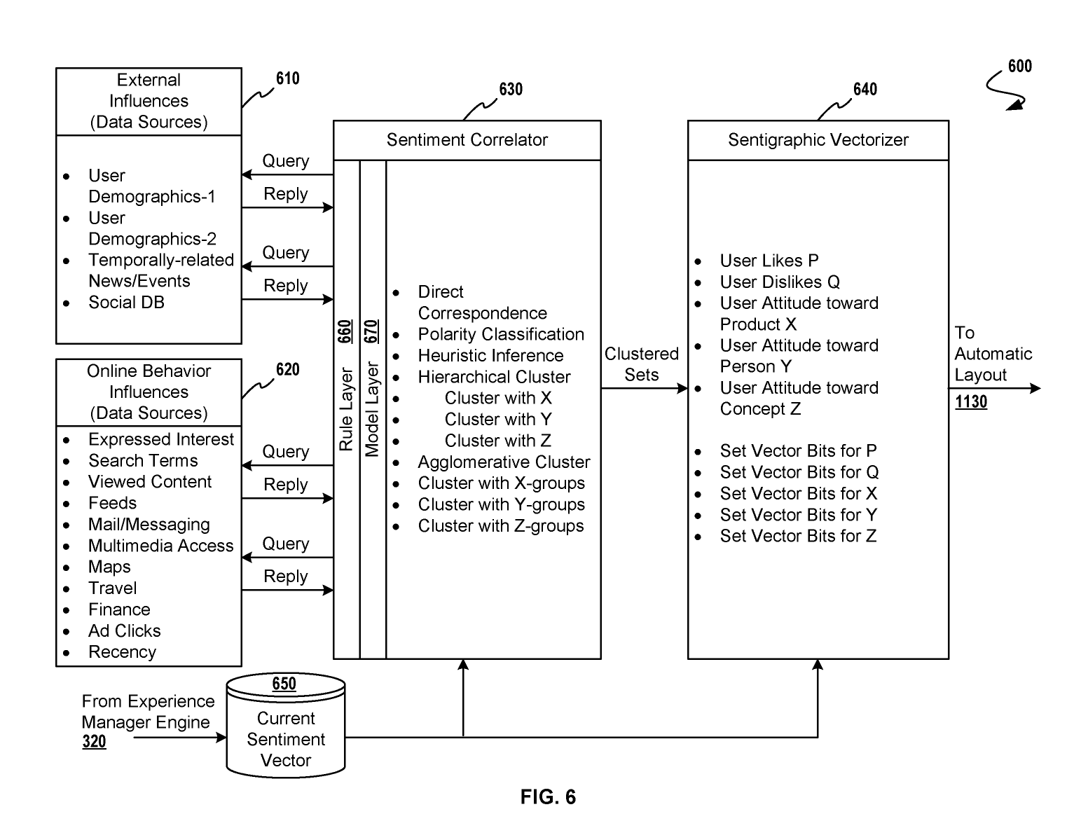

FIG. 6 is a depiction of a modularized system for processing user sentiment characteristics and publisher targeting goals, according to one embodiment. As shown, system 600 comprises a sentiment correlator 630 that is operable to query and retrieve to and from one or more data sources comprising external influences 610. Similarly, a sentiment correlator 630 is operable to query and retrieve to and from one or more data sources comprising online behavior influences 620. The operation of system 600 includes analysis of a current sentiment vector 650, such analysis including the application of rules in a rule layer 660 and the application of a model layer 670.

Referring to the sentiment correlator 630 and query/retrieval data sources corresponding to external influences 610, Table 2 shows various data sources and corresponding rules to be processed by the rule layer 660.

TABLE 2
External Influences

| Data Source | Rules |
|---|---|
| News | Use news relative to user's geographic location |
| | Do not use news sourced or relevant beyond a proximity |
| | to user's geographic location |
| Stock Market | Display messages from publishers associated with daily |
| Data | gainers |
| | Do not display messages from publishers associated with |
| | daily losers |
| Season | Score higher for messages pertinent to seasonal |
| | variations |
| Holidays | Score higher for messages pertinent to a particular |
| | holiday as the number of days before the holiday event |
| | decreases |
| | Score lower or zero after the holiday event |
| Time | Do not display messages with relevance outside of the |
| | time of day |

Referring to the sentiment correlator 630 and query/retrieval data sources corresponding to external influences 610, Table 3 shows various data sources and corresponding rules to be processed by the rule layer 660.

TABLE 3
Online Behavior Influences

| Data Source | Rules |
|---|---|
| Search | Use news relative to user's geographic location |
| | Do not use news sourced or relevant beyond a proximity |
| | to user's geographic location |
| Visits to blogs, content | Display messages from publishers associated with daily |
| specific | gainers |
| | Do not display messages from publishers associated with |
| | daily losers |
| Visits to news sites, content | Score higher for messages pertinent to seasonal |
| specific | variations |
| Mail, specifics from public | Score higher for messages pertinent to a particular |
| content | holiday as the number of days before the holiday event |
| | decreases |
| | Score lower or zero after the holiday event |
| Media sites, content specific | Score higher for messages relevant to specific content |
| Visits and click behavior at | Score higher for messages relevant to specific content |
| travel sites, map sites | |
| Ad clicks, content from | Score higher for messages relevant to specific content |
| specific messages | |
| Site revisits, site time/length | Extract specific content and score higher for messages |
| of visit, site click quantity | relevant to specific content |
| Wide swings in online | Modify scoring |
| behavior over time | |

Referring to the sentiment correlator 630 and query/retrieval data sources corresponding to external influences 610, Table 4 farther below shows various data sources and corresponding models to be processed by the model layer 670. In some cases, the relationship between some specific online behavior (e.g. a page visit) can be directly correlated to a specific interest or sentiment. For example a lengthy user visit to http://finance.yahoo.com/ might be directly correlated to the sentigraphic attribute-value pair (“interested in finance”=true).

Of course a user's demographic or sentiment might be lasting or fleeting. For example, a user's demographic such as “twenty years uninterrupted registration as a Republican” might be an indicator of that user's lasting pro-Republican demographic. Conversely, that user's Facebook posting of “I loved last night's American Idol contestants” might be indicative of a fleeting sentiment. Accordingly, demographic vector 502 and/or sentigraphic vector 514 each comprise a sub-vector for long decay treatment and a sub-vector for short decay treatment. Such treatment of demographic vectors or sentigraphic vectors are managed to treat long decay or short decay vectors differently. In one embodiment, various processes within the system 300 for managing online experiences based on user sentiment characteristics and publisher targeting goals might regard values included in long decay vectors as more reliable than values included in short decay vectors. Or, short decay vectors might indeed be decayed such that, over time, values in the short decay vectors are diminished or nullified. Such a decay vector technique might serve to improve reliability of correlation. Referring to sentiment correlator 630, embodiments are reasonable and envisioned where the inferring techniques (possibly including rules layer 660 and/or model layer 670) include operating upon a long decay demographic vector, operating upon a short decay demographic vector, operating upon a long decay sentigraphic vector, and/or operating upon a short decay sentigraphic vector.

In various embodiments, a wide range of correlation and/or information retrieval techniques might be applied. Such correlation techniques include, but are not limited to:
Correlation based on classification of the polarity of an extracted or expressed sentiment
Correlation based on classification of content being deemed to be subjective versus objective
Correlation using bag-of-words techniques
Correlation using inter-sentence contextual information
Correlation based on Naïve Bayes classification
Correlation based on machine learning using support vector machines (SVMs)
Correlation based on term presence versus term frequency
Correlation based on parts of speech
Correlation based on use of negation
Correlation based on domain adaptation and topic-sentiment techniques
Correlation based on relationship (inter-sentence, inter-document) features
Correlation based on discourse structure
Correlation based on language models
Correlation based on product feature extraction

In many cases a model might be employed, and such a model used in processing within the model layer 670. More specifically, some Internet sites have extremely high volume of visits, and are organized in such a manner that model-based correlation between a particular URL and inferences to sentiments can be mapped. Table 4 shows an example of such model-based inferences.

TABLE 4
Online Model-based Inferences

| Data Source | |
|---|---|
| (user page visit to URL) | Model Inference |
| http://hotjobs.yahoo.com/ | Correlate user to sentigraphic “job seeker” |
| http://autos.yahoo.com/ | Score higher for display of messages from |
| | automobile-related publishers |
| http://yahoo.com/ | Score higher for messages pertinent to self help |
| mentalhealthzone/ | publishers |

Of course, the above descriptions of rules and models are purely exemplary, and any number of additional rules and models might be defined. Additional rules and models might be defined to correlate within a sentiment correlator 630, for example:
Correlate to show shopping ads for people from Karnataka, Andhra Pradesh, Maharashtra (states in India) on Ugadi as the date of a local festival approaches.
Correlate to never show an iPod ad when the user expresses a negative sentiment toward iPods.

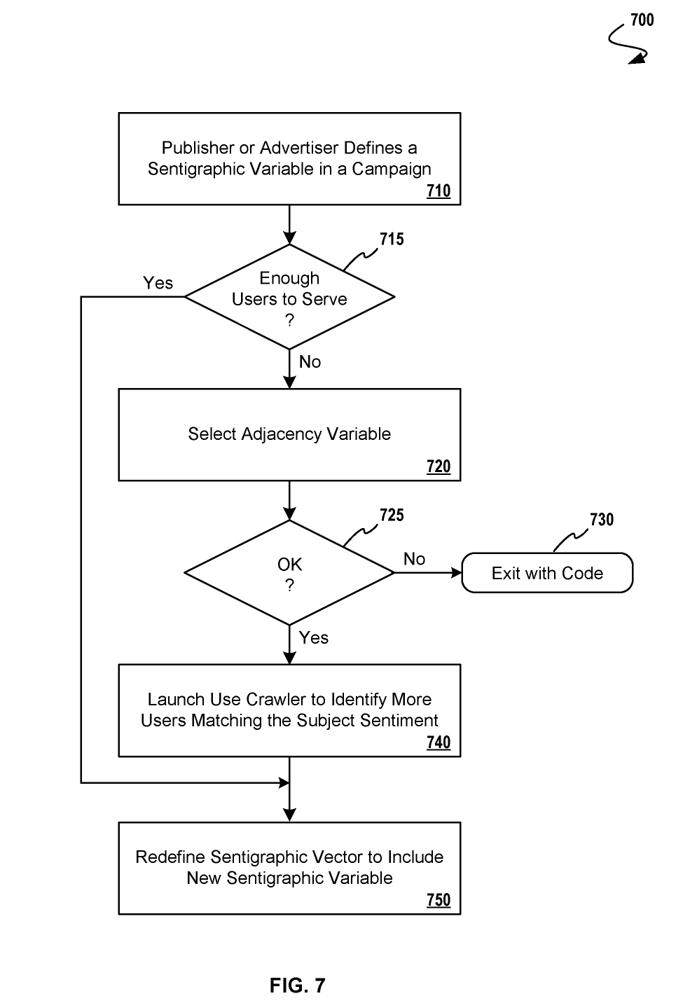

FIG. 7 is a flowchart showing operations for processing user sentiment characteristics and publisher targeting goals, according to one embodiment. The method 700 describes an exemplary processing flow, which flow might be implemented within the context of any of the foregoing figures. As shown, the method 700 commences at an operation whereby a publisher or advertiser defines a sentigraphic variable in a campaign (at 710). In some cases, an advertiser might wish to display messages to target users using a particular sentiment, feeling or predilection. That sentiment might be codified in available data (e.g. registration as a member of the Republican Party). In other cases, retrieval of a sentiment might not be direct, or there might not be a large corpus of users known to hold the sentiment (e.g. registration as a member of the Illuminati Party), and an adjacent variable might be used (e.g. registration as a member of the Independent Party). The method executes processing to reach a decision (at 715) if the sentigraphic variable is supported by sufficient underlying rules, models, and data sources for correlating a sentiment (see sentiment correlator 630) and, if so, method 700 redefines a sentigraphic vector to include the aforementioned sentigraphic variable. In absence of sufficient underlying rules, models, and data sources for correlating a sentiment (see sentiment correlator 630), method 700 proceeds to select an adjacency variable. In some circumstances, although there may not be a total absence of sufficient underlying rules, models, and data sources for correlating a sentiment, a low threshold of confidence might result in the decision 715 being taken to select an adjacency variable 720. The method executes processing to reach a decision (at 725) if the sentigraphic adjacency variable is supported by sufficient underlying rules, models, and data sources for correlating a sentiment (see sentiment correlator 630) and, if so, method 700 proceeds to launch a crawler to identify more users matching the sentiment (at 740) described in operation 710. In some cases an appropriate adjacency variable might not be identified by operation 720. In such a case, method 700 exits (at 730).

Whether using the sentigraphic variable described in operation 710, or using the adjacency variable selected in 720, the method 700 updates or redefines (at 750) the sentigraphic vector (possibly within the context of sentigraphic vectorizer 640) to include the sentigraphic variable.

It should be emphasized that in cases where an adjacency variable is selected, the adjacency variable might be selected fully automatically or it might be selected in a computer-aided manner-possibly even involving human-to-human communication with the purpose of selecting an appropriate adjacency variable.

FIG. 8 is a depiction of a modularized system for processing automated page layout using sentiment characteristics, according to one embodiment. As shown, system 800 comprises a dynamic compositor 830 that is operable to query and retrieve to and from base content data sources 810. Similarly, a dynamic compositor 830 is also operable to query and retrieve to and from one or more data sources comprising additional content 820.

The operation of system 800 includes analysis of a current sentiment vector 850, such analysis including the application of rules in a rule layer 860 and possibly application of a model layer 870. The dynamic compositor 830 serves to query and retrieve markup materials in the form of base content 810 as well as to query and retrieve markup materials in the form of additional content 820. Such queries may be formed in whole or in part by operation of algorithms in the rule layer 860 and/or in the model layer 870. For example, the dynamic compositor might, in conjunction with one or more rules in the rule layer, query base content 810 to retrieve base content and additional content corresponding through rules or models to the current sentiment vector. More specifically, if a sponsor wins a bid to display a message to a user fitting some particular demographics (e.g. male, college graduate, etc), the sponsor might then wish to further refine the message placement to correspond with that user's sentiments. Still more specifically, and strictly as an example, sponsor Ford Motor Company might wish to place messages regarding their top selling models to male college graduates. However, the placement of a message pertaining to a specific model (e.g. F-150 diesel versus Hybrid Focus) might depend on the user's sentiment toward alternative energy. Continuing with this case, the rule layer 860 might codify such a specific rule for placement of a message for a Hybrid Focus when the current sentiment vector contains a positive sentiment toward alternative energy. Of course application of rules is but one technique for resolving to content based on sentiment. A model, or multiple models might be included in the mode layer 870. A model might be a simple model such as “If no rules were applied, then select a default”, or “If a rule of strength M or greater has been applied, then do not apply any models”. In this sense, a dynamic compositor creates markup including selecting messages and/or selecting advertisements based on the current sentiment vector.

A dynamic compositor 830 might apply rules and/or models within the context of queries and retrieval from base content 810 and additional content 820, and also a dynamic compositor 830 might apply rules and/or models for creating the markup for messaging. In some cases, a dynamic compositor may create markup including multiple pages (e.g. following a storyboard, following a page sequence, inserting a glue page, etc). In other cases, a dynamic compositor may create markup including adherence to a prescribed layout (e.g. a rectilinear layout, a whitespace ratio, a maximum/minimum media space, etc).

It is reasonable and envisioned that overall composition of a page or pages might be implemented in multiple stages. As an example, overall composition might be divided into tasks performed by a dynamic compositor 830 and other tasks performed by a static compositor 840. As shown a static compositor 840 serves to apply ornamentation to pages, where such ornamentation may be in the form of colors, themes, typefaces, and/or other ornamentation that affects overall ambience of the page. In fact, embodiments of a dynamic compositor 830 and a static compositor 840, or combinations thereof, are operable for performing automated layout using the full range of display page design, flow and ornamentation including storyboard layout, page sequence layout, glue page layout, rectilinear push-pull layout, media selection, media sequence selection, message selection, message sequence selection, advertisement layout, color scheme layout, ambience scheme layout, theme layout, etc.

Of course, the above descriptions of dynamic and static composition, and discussion of rules and models are purely exemplary, and any number of additional composition stages, additional rules, and additional models might be defined. Additional compositors, rules and models might be defined to correlate within a dynamic compositor 830, for example:
If a user of age less than seven years of age is online, correlate to a higher score for cartoon themes and, in particular, correlate to the user's favorite cartoon.
Based on weather in the locality, change the page layout to correspond. When it is raining heavily, rainy-day themes and umbrella ads can be composited.
If the user is known to be travelling in a popular tourist location, composite to include famous local restaurant information.
On Friday evening, if the user is single, composite to show him/her dating-related messages.
If there is an earthquake, tornado, tsunami, flood or any natural catastrophe news and the user is reading about them in the news and/or blogging sites, correlate to display messages about relief donations and charity causes.
If the user is reading about job openings, joining career groups, looking for some courses, and/or corresponds with mails about interviews, composite to show job-related messages.

As is now understood from the foregoing descriptions, a page or plurality of pages is composited using influences from the sentiment vector, thus compositing a page that is consistent both in content and presentation with any one or more factors known about the user.

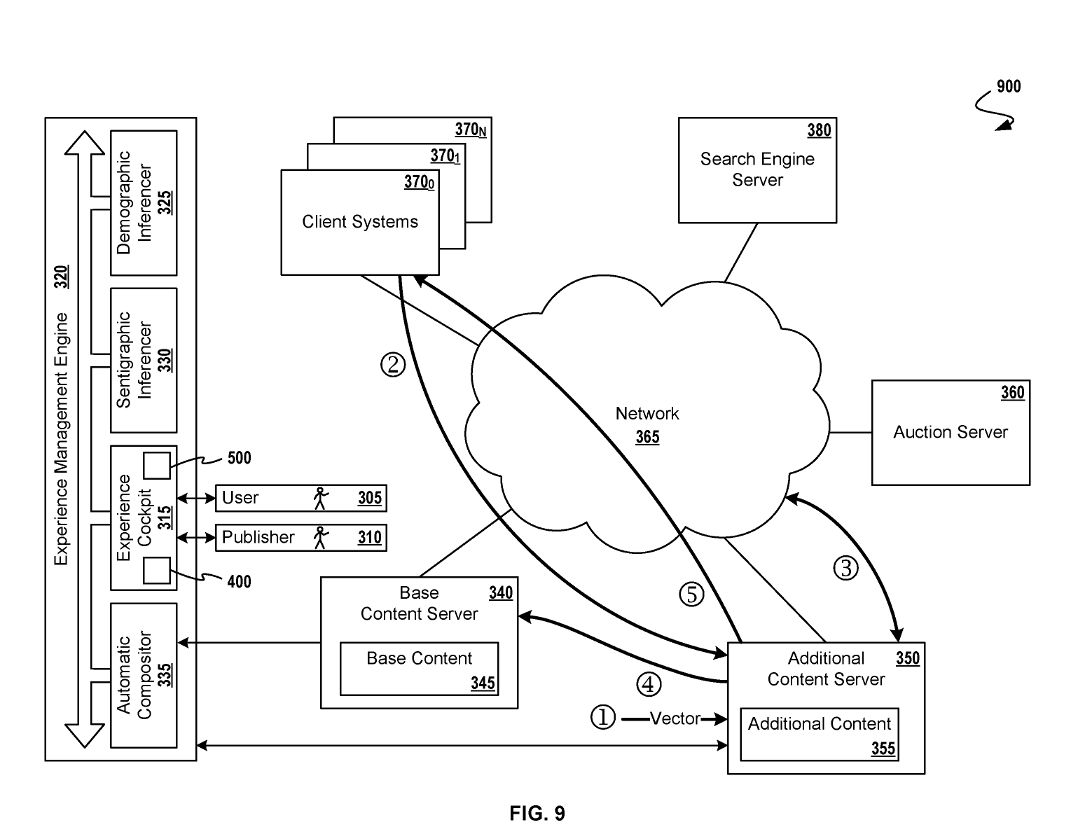

FIG. 9 is a diagrammatic representation of a client-server computing environment in the exemplary form of several computer systems, within which a set of instructions may be executed, according to one embodiment. As shown, the system 900 is a computer-implemented method for presenting to a user a message in the form of one or more display pages based on combined user demographics, and for serving display pages based on user sentiment-related relevance attribute values. In this embodiment, data and processing commences at #1 when the additional content server 350 is configured for receiving, from a server, a sentigraphic vector data structure wherein the sentigraphic vector is configured to indicate one or more said user sentiment-related relevance attributes. Processing continues at #2 when an additional content server retrieves from the client system at least a partial demographic data structure. Such a partial demographic data structure might be in the form of a cookie retrieved from the client system. At #3, processing continues by inferring at additional content server 350, via a network 365, at least one sentigraphic attribute value based at least in part on the demographic data structure yet wherein the inferred sentigraphic attribute value is not present in the demographic data structure. The sentiment correlator 630, together with rules 660 and models 670, might also be engaged in this processing. Further, additional content in the form of winning messages retrieved from an auction server 360 might be incorporated into processing within this embodiment. Processing continues at #4 where, having additional content 355, a base content server 340 might commence performing automated layout of display pages using one or more sentigraphic attribute values. Finally, at #5, processing continues by presenting to the user, at the client system, the message in the form of one or more automatically composited display pages. Of course, any processing instructions and/or any data may be accessible to any operation, thus the sequence shown is purely illustrative, and other sequences are possible and envisioned.

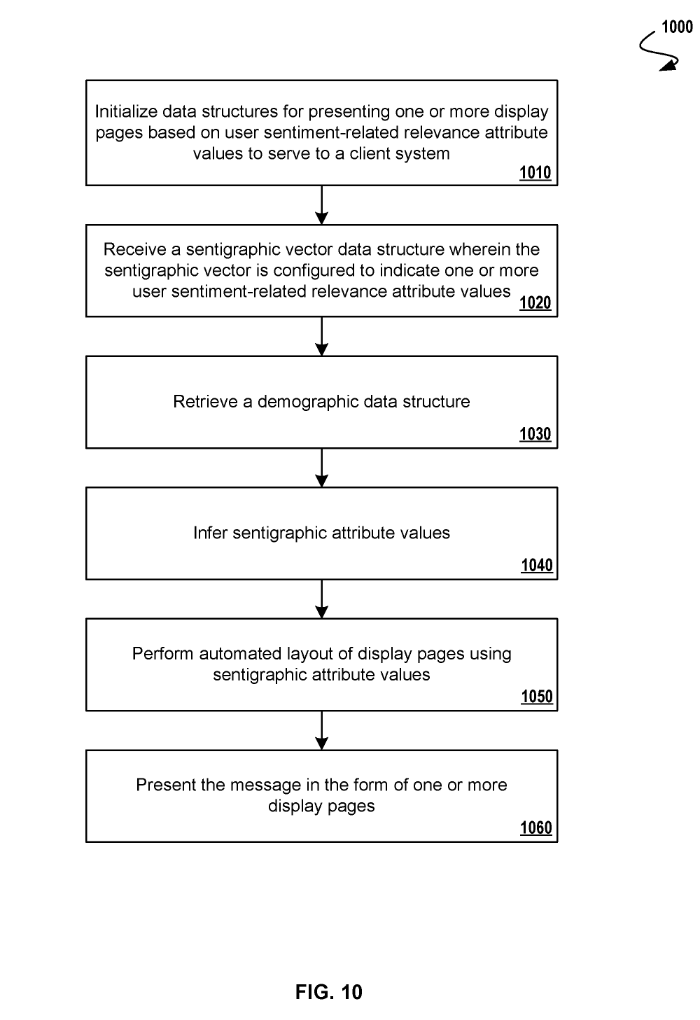

FIG. 10 is a flowchart showing operations for processing user sentiment characteristics and publisher targeting goals, according to one embodiment. As shown, the method 1000 implements compositing and display of one or more pages based on combined user demographics and user sentiment-related relevance attribute values. The method commences by the initialization of data structures (at 1010) and proceeds to process operations for receiving a sentigraphic vector data structure (at 1020). In exemplary embodiments, the sentigraphic vector data structure is configured to indicate one or more user sentiment-related relevance attribute values. Additionally, the method 1000 operates for retrieving demographic data (at 1030). Such demographic data might come in the form of a user's cookie, or in the form of a Yahoo! profile, or a LinkedIn profile, or from any other source for that matter. In the embodiment shown in FIG. 10, the user sentiment-related relevance attribute values are combined with the demographic data and passed into operations for inferring sentigraphic attribute values, based at least in part on the demographic data structure (see operation 1040). The method 1000 continues, performing automated layout of display pages using demographic data and sentigraphic attribute values to drive the characteristics of the layout (see operation 1050), and presenting a message in the form of one or more display pages (at 1060).

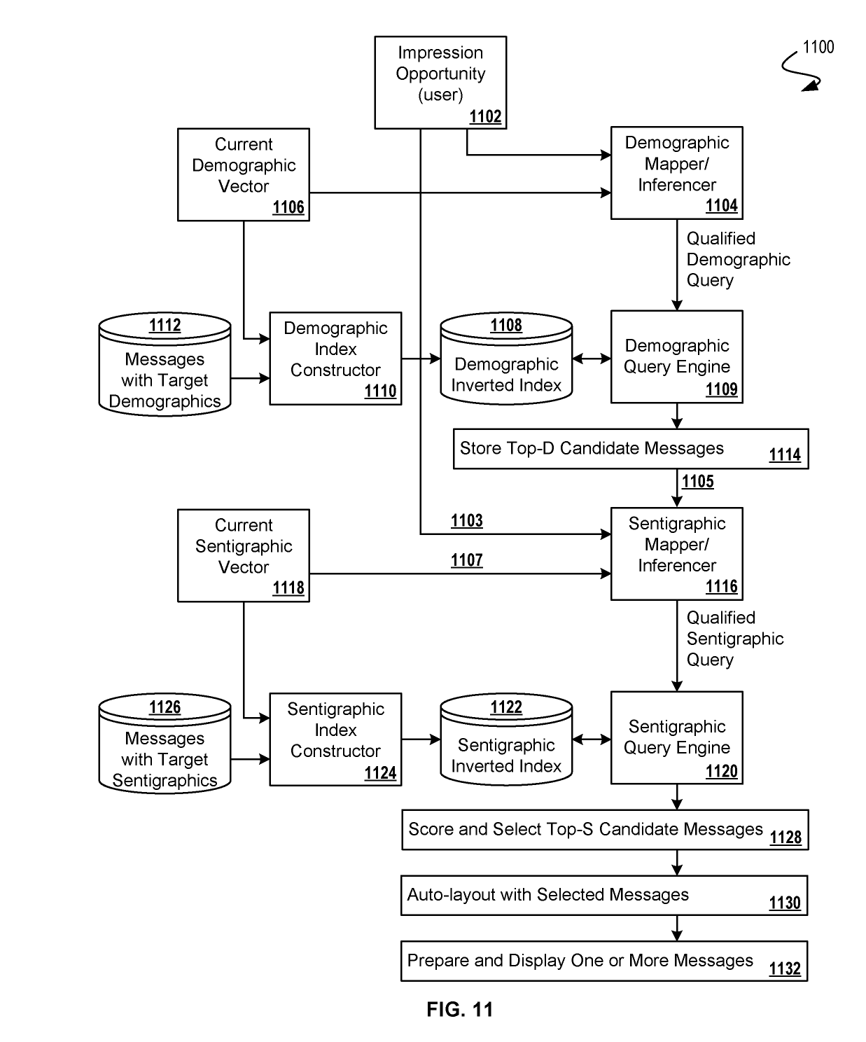

FIG. 11 is a diagrammatic representation of a data flow for presenting pages 1100 based on user sentiment characteristics and publisher targeting goals, according to one embodiment. The embodiment of FIG. 11 may be implemented in the context of any of the figures FIG. 1 through FIG. 10, or in any other context. As shown, FIG. 11 depicts computer-implemented techniques for presenting to a user one or more messages in the form of display pages, based on combined user demographics and user sentiment-related relevance attribute values. The data flow represents one possible data flow within the context of FIG. 11. Of course, any data storage may be accessible to any operation, thus the data flow shown is purely illustrative, and other data flows are possible and envisioned.

Overall, the FIG. 11 covers data flow and processing beginning with the availability of an impression opportunity (at 1102) and ending with display of one or more messages to a user (at 1132). As shown, the data flow for presenting pages 1100 implements data flow for presenting pages based on user sentiment characteristics and publisher targeting goals, which data flow includes a first set of operations for selecting only a set of top-D messages based largely on demographics, followed by a second set of operations for selecting from among those top-S message on the basis of sentigraphics.

Strictly for illustrative purposes, the first set of operations begins with the availability of an impression opportunity (at 1102), which impression opportunity corresponds to a particular user, and more particularly, the impression opportunity (at 1102) corresponds to some demographics and some sentigraphics of a particular user. Thus, a demographic mapper/inferencer can operate (at 1104) to retrieve both the impression opportunity and a current demographic vector. The current demographic vector is representative of the organization of the demographic inverted index (see dataset 1108). That is, although the demographics of a particular user might be codified using attribute-value pairs for example, given a set of attribute-value pairs as in (gender=male, years_of age=29, residence_ZIP=90210), the current demographic vector might be codified as a set of somewhat different attribute-value pairs such as (gender−[male∥female], boomer=[T∥F], GenX=[T∥F], GenY=[T∥F], State=[<one of 50>]). Thus the demographic mapper/inferencer 1104 produces one or more queries (i.e. a qualified query) that correspond to the organization of the demographic inverted index 1108. In this example, the qualified query includes attribute-value pairs (gender=male, GenX=T, State=California). The qualified query is then used to retrieve a set of top-D candidate messages from the current demographic vector (at 1 106). Of course, the demographic inverted index 1108 is constructed using a demographic index constructor 1110 that in turn uses a dataset of message content with target demographics (see dataset 1112), which message content is tagged with at least some target demographics.

Processing of the results of the demographic query engine 1109 includes storing in memory a set of messages (at 1114), wherein a message comprising at least one demographic attribute-value pair is present.

Given the results of the query stored in memory (at 1114), the second set of operations commences. As shown, the sentigraphic mapper/inferencer 1116 operates to retrieve the impression opportunity 1102 (via path 1103) and a current sentigraphic vector 1118 (via path 1107), as well as retrieving (via path 1105) from the data structure only the top-D candidate messages. The sentigraphic mapper/inferencer operations (at 1116) are then processed. The current sentigraphic vector data structure is representative of the organization of the sentigraphic inverted index (see dataset 1122). That is, although the sentigraphics of a particular user might be codified using attribute-value pairs for example, (iPod=Pro, solar_power=Pro, whaling=Con), the current sentigraphic vector data structure might be codified as attribute-value pairs (digital_music=[Pro∥Con], alternative_energy=[Pro∥Con]). Thus the sentigraphic mapper/inferencer 1116 produces one or more queries (i.e. a qualified query) that correspond to the organization of the sentigraphic inverted index 1122. In this example, the qualified query includes attribute-value pairs (digital_music=Pro, alternative_energy=Pro). The qualified sentigraphic query is then used to retrieve a set of top-S candidate messages (at 1128). Of course, the sentigraphic inverted index 1122 is constructed using a sentigraphic index constructor 1124 that in turn uses a dataset of message content with target sentigraphics (see dataset 1126), which message content is tagged with at least some target sentigraphics.

Now, returning to the discussion of the sentigraphic mapper/inferencer 1116, sentigraphic mapper/inference operations include inferring sentigraphic attribute values based on at least one demographic attribute-value pair wherein the sentigraphic attribute value is not present in said demographic attribute-value pair. Processing in operation 1116 may include any or all of the processing as disclosed supra in the discussion of FIG. 6. In particular, processing in operation 1116 may result in the correlation of sentiments as described in the discussion of the sentiment correlator 630, and may result in sentigraphic vectorization as described in the discussion of the sentigraphic vectorizer 640.

In as much as the results of any qualified sentigraphic query may produce a plurality of top-S candidate messages, the plurality of messaged are scored and selected (at 1128). At least a portion of the scored top-S candidate messages are selected and subjected to processes for performing automated layout of display pages (at 1130) using at least one message selected based on at least one sentigraphic attribute value. Such messages, being available as included within display pages are then prepared (at 1132) for presenting to a user.

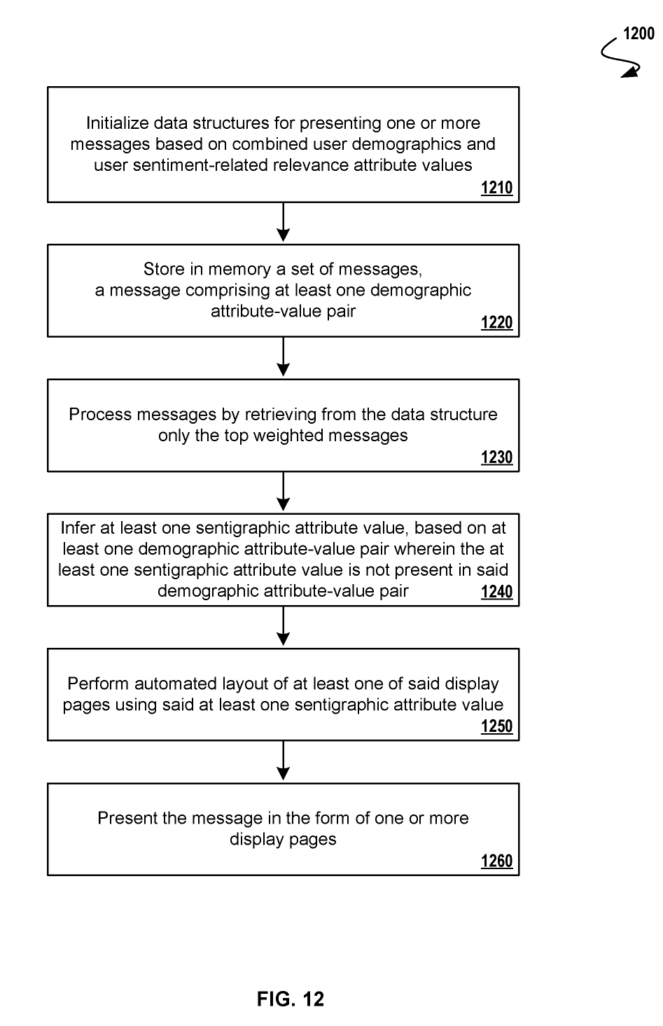

FIG. 12 is a flowchart showing a method for presenting pages 1200 based on user sentiment characteristics and publisher targeting goals, according to one embodiment. The method commences by the initialization of data structures (at 1210) and proceeds to process operations for presenting a message in the form of one or more display pages based on combined user demographics and user sentiment-related relevance attributes. In the embodiment shown, operation 1220 serves for storing, in memory, a set of messages, a message comprising at least one demographic attribute-value pair. In some situations, there might be a large number of messages in memory, and accordingly operation 1230 retrieves only the top weighted messages before processing those top-weighted messages. Operation 1240 serves for inferring sentigraphic attribute values based on demographic attribute-value pairs wherein the sentigraphic attribute value is not present in the demographic attribute-value pairs. The method 1200 continues by performing automated layout (at 1250) of display pages using the inferred sentigraphic attribute value, finally presenting to the user (at 1260) the message in the form of one or more display pages.

### Configurations Using a Network of Computers

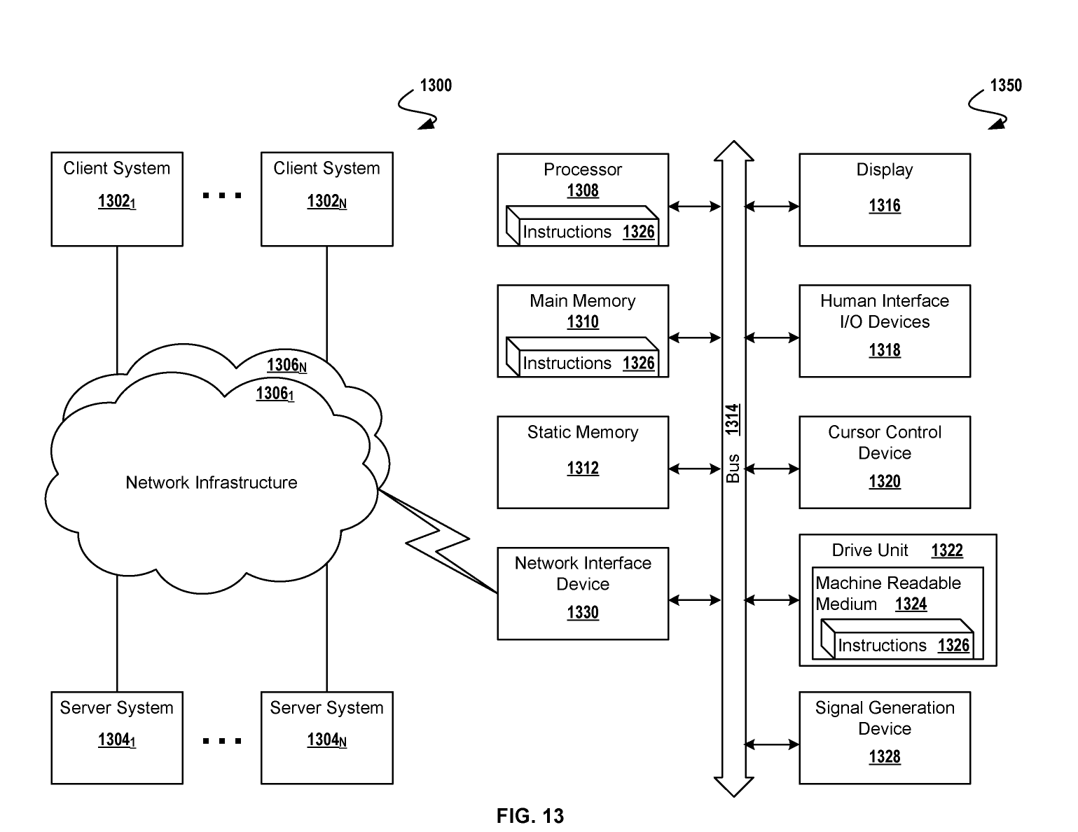

FIG. 13 is a diagrammatic representation of a network 1300, including nodes for client computer systems 1302₁ through 1302_{N}, nodes for server computer systems 1304₁ through 1304_{N}, and nodes for network infrastructure 1306₁ through 1306_{N}, any of which nodes may comprise a machine 1350 within which a set of instructions for causing the machine to perform any one of the techniques discussed above may be executed. The embodiment shown is purely exemplary, and might be implemented in the context of one or more of the figures herein.

Any node of the network 1300 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1350 includes a processor 1308 (e.g. a processor core, a microprocessor, a computing device, etc), a main memory 1310 and a static memory 1312, which communicate with each other via a bus 1314. The machine 1350 may further include a display unit 1316 that may comprise a touch-screen, or a liquid crystal display (LCD), or a light emitting diode (LED) display, or a cathode ray tube (CRT). As shown, the computer system 1350 also includes a human input/output (I/O) device 1318 (e.g. a keyboard, an alphanumeric keypad, etc), a pointing device 1320 (e.g. a mouse, a touch screen, etc), a drive unit 1322 (e.g. a disk drive unit, a CD/DVD drive, a tangible computer readable removable media drive, an SSD storage device, etc), a signal generation device 1328 (e.g. a speaker, an audio output, etc), and a network interface device 1330 (e.g. an Ethernet interface, a wired network interface, a wireless network interface, a propagated signal interface, etc).

The drive unit 1322 includes a machine-readable medium 1324 on which is stored a set of instructions (i.e. software, firmware, middleware, etc) 1326 embodying any one, or all, of the methodologies described above. The set of instructions 1326 is also shown to reside, completely or at least partially, within the main memory 1310 and/or within the processor 1308. The set of instructions 1326 may further be transmitted or received via the network interface device 1330 over the network bus 1314.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc); or any other type of media suitable for storing or transmitting information.

While the invention has been described with reference to numerous specific details, one of ordinary skill in the art will recognize that the invention can be embodied in other specific forms without departing from the spirit of the invention. Indeed, one of ordinary skill in the art will realize that this patent covers online media other than web pages delivered to computers, such online media including advertising on mobile phones, electronic billboards, televisions, game consoles, or other display devices, any of which may deliver textual, graphical, video, or audio media. Also, one of ordinary skill in the art will realize that techniques such as opinion mining, subjectivity summarization, and/or techniques for minimum cut-based classification of context and subjectivity are strictly exemplary methods. Other techniques such as indexed stores, constraint evaluation systems, or numerical optimization systems might use data structures and algorithms might be used in addition to or instead of the techniques disclosed herein. Thus, one of ordinary skill in the art would understand that the invention is not to be limited by the foregoing illustrative details, but rather is to be defined by the appended claims.

We claim:

1. A computer-implemented method for presenting to a user, a message in the form of one or more display pages based on combined user demographics and user sentiment-related relevance attribute values to serve to a client system, the method comprising:
receiving, from a server, a sentigraphic vector data structure wherein the sentigraphic vector is configured to indicate one or more said user sentiment-related relevance attribute values;
retrieving at least a partial demographic data structure;
inferring, at a server, at least one sentigraphic attribute value, based at least in part on the demographic data structure wherein the at least one sentigraphic attribute value is not present in said partial demographic data structure;
performing automated layout of at least one of said display pages using said at least one sentigraphic attribute value; and
presenting to the user, at the client system, the message in the form of one or more of the said display pages.

2. The method of claim 1, wherein the retrieving, from the client system at least a partial demographic data structure includes receiving at least a portion of a cookie.

3. The method of claim 1, wherein the retrieving, from the client system at least a partial demographic data structure includes retrieving a user profile from an online database.

4. The method of claim 1, wherein the inferring, based at least in part on the demographic data structure at least one sentigraphic characteristic includes extracting sentiment from at least one of, the user's expressed interest, the user's search terms, the user's recently viewed content, the user's web page feeds, the user's public messaging, the user's recently viewed pages, the user's recent ad clicks.

5. The method of claim 1, wherein the inferring, is based on at least one of, a long decay demographic vector, a short decay demographic vector, a long decay sentigraphic vector, a short decay sentigraphic vector.

6. The method of claim 1, wherein the performing automated layout of at least one of said display pages includes at least one of, storyboard layout, page sequence layout, glue page layout, rectilinear push-pull layout, media selection, media sequence selection, message selection, message sequence selection, advertisement layout, color scheme layout, ambience scheme layout, theme layout.

7. A computer-implemented method for presenting to a user, a message in the form of one or more messages based on combined user demographics and user sentiment-related relevance attribute values to serve to a client system, the method comprising:
storing, in memory, a set of messages, a message comprising at least one demographic attribute-value pair;
processing, in a processor, said messages by retrieving from the data structure only the top weighted messages;
inferring, at a server, at least one sentigraphic attribute value, based on at least one demographic attribute-value pair wherein the at least one sentigraphic attribute value is not present in said demographic attribute-value pair;
performing automated layout of at least one of said display pages using said at least one sentigraphic attribute value; and
presenting to the user, at the client system, the message in the form of one or more of the said display pages.

8. The method of claim 8, wherein the processing only the top weighted messages includes messages in association with a publishing campaign.

9. An apparatus for presenting to a user, a message in the form of one or more display pages based on combined user demographics and user sentiment-related relevance attribute values to serve to a client system, comprising:
a module for receiving, from a server, a sentigraphic vector data structure wherein the sentigraphic vector is configured to indicate one or more said user sentiment-related relevance attribute values;
a module for retrieving at least a partial demographic data structure;
a module for inferring, at a server, at least one sentigraphic attribute value, based at least in part on the demographic data structure wherein the at least one sentigraphic attribute value is not present in said partial demographic data structure;
a module for performing automated layout of at least one of said display pages using said at least one sentigraphic attribute value; and
a module for presenting to the user, at the client system, the message in the form of one or more of the said display pages.

10. The apparatus of claim 9, wherein the retrieving, from the client system at least a partial demographic data structure includes receiving at least a portion of a cookie.

11. The apparatus of claim 9, wherein the retrieving, from the client system at least a partial demographic data structure includes retrieving a user profile from an online database.

12. The apparatus of claim 9, wherein the inferring, based at least in part on the demographic data structure at least one sentigraphic characteristic includes extracting sentiment from at least one of, the user's expressed interest, the user's search terms, the user's recently viewed content, the user's web page feeds, the user's public messaging, the user's recently viewed pages, the user's recent ad clicks.

13. The apparatus of claim 9, wherein the inferring, is based on at least one of, a long decay demographic vector, a short decay demographic vector, a long decay sentigraphic vector, a short decay sentigraphic vector.

14. The apparatus of claim 9, wherein the performing automated layout of at least one of said display pages includes at least one of, storyboard layout, page sequence layout, glue page layout, rectilinear push-pull layout, media selection, media sequence selection, message selection, message sequence selection, advertisement layout, color scheme layout, ambience scheme layout, theme layout.

15. A computer readable medium comprising a set of instructions which, when executed by a computer, cause the computer to present to a user, a message in the form of one or more display pages based on combined user demographics and user sentiment-related relevance attribute values to serve to a client system, the instructions for:
receiving, from a server, a sentigraphic vector data structure wherein the sentigraphic vector is configured to indicate one or more said user sentiment-related relevance attribute values;
retrieving at least a partial demographic data structure;
inferring, at a server, at least one sentigraphic attribute value, based at least in part on the demographic data structure wherein the at least one sentigraphic attribute value is not present in said partial demographic data structure;
performing automated layout of at least one of said display pages using said at least one sentigraphic attribute value; and
presenting to the user, at the client system, the message in the form of one or more of the said display pages.

16. The computer readable medium of claim 15, wherein the retrieving, from the client system at least a partial demographic data structure includes receiving at least a portion of a cookie.

17. The computer readable medium of claim 15, wherein the retrieving, from the client system at least a partial demographic data structure includes retrieving a user profile from an online database.

18. The computer readable medium of claim 15, wherein the inferring, based at least in part on the demographic data structure at least one sentigraphic characteristic includes extracting sentiment from at least one of, the user's expressed interest, the user's search terms, the user's recently viewed content, the user's web page feeds, the user's public messaging, the user's recently viewed pages, the user's recent ad clicks.

19. The computer readable medium of claim 15, wherein the inferring, is based on at least one of, a long decay demographic vector, a short decay demographic vector, a long decay sentigraphic vector, a short decay sentigraphic vector.

20. The computer readable medium of claim 15, wherein the performing automated layout of at least one of said display pages includes at least one of, storyboard layout, page sequence layout, glue page layout, rectilinear push-pull layout, media selection, media sequence selection, message selection, message sequence selection, advertisement layout, color scheme layout, ambience scheme layout, theme layout.
